(19) United States
(12) Patent Application Publication
(10) Pub. No.: US 2012/0232972 A1
(43) Pub. Date: Sep. 13, 2012

(54) RETAILING METHODS AND SYSTEMS

(75) Inventor: Seth M. Priebatsch, Boston, MA (US)

(73) Assignee: SCVNGR, Inc., Boston, MA (US)

(21) Appl. No.: 13/042,937

(22) Filed: Mar. 8, 2011

(51) Int. Cl. G06Q 30/00

(52) U.S. Cl. 705/14.15

(57) ABSTRACT

A method of conducting retailing promotions uses a computerized retailing promotion system communicating with client devices operated by a plurality of consumers and merchants over a communications network. The method includes the steps of: (a) selling vouchers to consumers operating client devices using the computerized retailing promotion system, each voucher including a deal at one of a plurality of sequential levels that can be redeemed by a consumer at a merchant for a specified product or service, wherein a consumer is entitled to purchase a voucher having a deal at a higher level only if the consumer has purchased a voucher having a deal at an immediately lower level; and (b) for each consumer redemption of a voucher at a merchant: (i) receiving notification at the computerized retailing promotion system from the merchant when the consumer redeems the voucher; (ii) making a payment to the merchant using the computerized retailing promotion system; (iii) unlocking a deal at the next sequential level, if available, and enabling the consumer to purchase a voucher for that deal; and (iv) repeating steps (i) to (iii) until deals at all levels of a promotion have been sold to the consumer.

### BACKGROUND

The present application relates generally to retailing promotions and, more particularly, to methods and systems for promoting sales of products and services using redeemable vouchers.

### BRIEF SUMMARY OF THE DISCLOSURE

A method of conducting retailing promotions in accordance with one or more embodiments uses a computerized retailing promotion system communicating with client devices operated by a plurality of consumers and merchants over a communications network. The method includes the steps of: (a) selling vouchers to consumers operating client devices using the computerized retailing promotion system, each voucher including a deal at one of a plurality of sequential levels that can be redeemed by a consumer at a merchant for a specified product or service, wherein a consumer is entitled to purchase a voucher having a deal at a higher level only if the consumer has purchased a voucher having a deal at an immediately lower level; and (b) for each consumer redemption of a voucher at a merchant: (i) receiving notification at the computerized retailing promotion system from the merchant when the consumer redeems the voucher; (ii) making a payment to the merchant using the computerized retailing promotion system; (iii) unlocking a deal at the next sequential level, if available, and enabling the consumer to purchase a voucher for that deal; and (iv) repeating steps (i) to (iii) until deals at all levels of a promotion have been sold to the consumer.

A computerized retailing promotion system in accordance with one or more embodiments is capable of communicating with client devices operated by a plurality of consumers and merchants over a communications network. The computerized retailing promotion system is utilized for selling vouchers to consumers via client devices operated by the consumers. Each voucher includes a deal at one of a plurality of sequential levels that can be redeemed by a consumer at a merchant for a specified product or service. A consumer is entitled to purchase a voucher having a deal at a higher level only if the consumer has purchased a voucher having a deal at an immediately lower level. For each consumer redemption of a voucher at a merchant, the computerized retailing promotion system is configured to: (i) receive notification from the merchant when the consumer redeems the voucher; (ii) make a payment to the merchant; (iii) unlock a deal at the next sequential level, if available, and enable the consumer to purchase a voucher for that deal; and (iv) repeat steps (i) to (iii) until deals at all levels of a promotion have been sold to the consumer.

A computer program product is provided for conducting retailing promotions in accordance with one or more embodiments. The computer program product resides on a non-transitory computer readable medium having a plurality of instructions stored thereon which, when executed by a computer processor, cause that processor to: (a) sell vouchers to consumers operating client devices, each said voucher including a deal at one of a plurality of sequential levels that can be redeemed by a consumer at a merchant for a specified product or service, wherein a consumer is entitled to purchase a voucher having a deal at a higher level only if the consumer has purchased a voucher having a deal at an immediately lower level; and (b) for each consumer redemption of a voucher at a merchant: (i) receive notification from the merchant when the consumer redeems the voucher; (ii) make a payment to the merchant; (iii) unlock a deal at the next sequential level, if available, and enable the consumer to purchase a voucher for that deal; and (iv) repeat steps (i) to (iii) until deals at all levels of a promotion have been sold to the consumer.

### BRIEF DESCRIPTION OF THE DRAWINGS

FIG. 1 is a simplified block diagram illustrating an exemplary retailing promotion system in accordance with one or more embodiments.

FIG. 2 is a simplified flowchart illustrating an exemplary retailing promotion method in accordance with one or more embodiments.

FIG. 3 is a screenshot of an exemplary deal advertised to consumers in accordance with one or more embodiments.

FIGS. 4A-4C are screenshots of exemplary deals at different levels advertised to consumers in accordance with one or more embodiments.

### DETAILED DESCRIPTION

Various embodiments disclosed herein are directed to methods and systems for conducting retailing promotions. As will be discussed in greater detail below, a retailing promotion system is used to sell vouchers to consumers for deals that can be redeemed for products or services from merchants. Each voucher includes a deal at one of multiple sequential levels. Consumers must buy and redeem a deal at one level to be able to access a deal at the next level. For example, after a consumer has purchased and redeemed a deal at a first level, the system unlocks a deal at the second level, which the consumer is entitled to purchase. Once that deal has been purchased and redeemed, the consumer is entitled to purchase a deal at the third level, and so on. The system thus produces a structured series of interactions between consumers and merchants, which provides an effective way for merchants to attract new customers, build loyalty, and turn newcomers into regular customers.

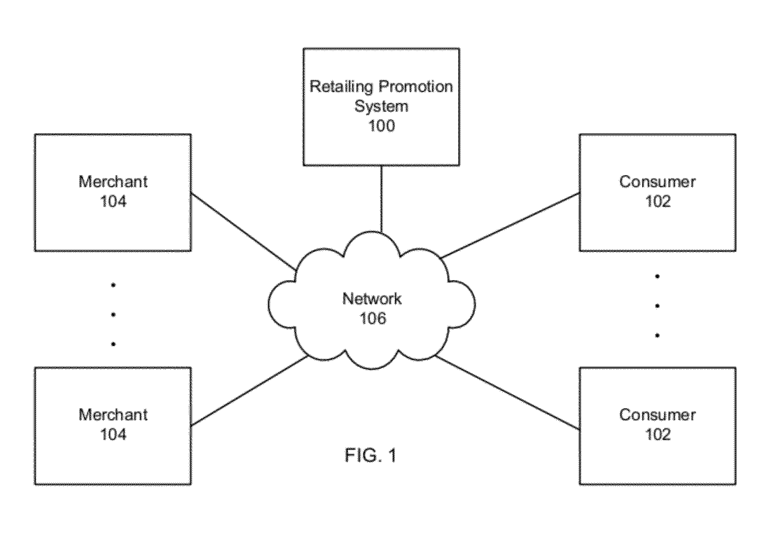

FIG. 1 illustrates an exemplary network, in which a retailing promotion system 100 in accordance with one or more embodiments may be implemented. The retailing promotion system 100 is preferably implemented in a computer server system, which communicates with a plurality of client devices operated by the users of the system 100, including consumers 102 and merchants 104. The client devices communicate with the system 100 over a communications network 106. The communications network 106 may comprise any network or combination of networks including, without limitation, the Internet, a local area network, a wide area network, a wireless network, and a cellular network.

The client devices operated by users to access the retailing promotion system 100 can comprise any computing device that can communicate with the computer server system including, without limitation, personal computers, smart phones, and cell phones.

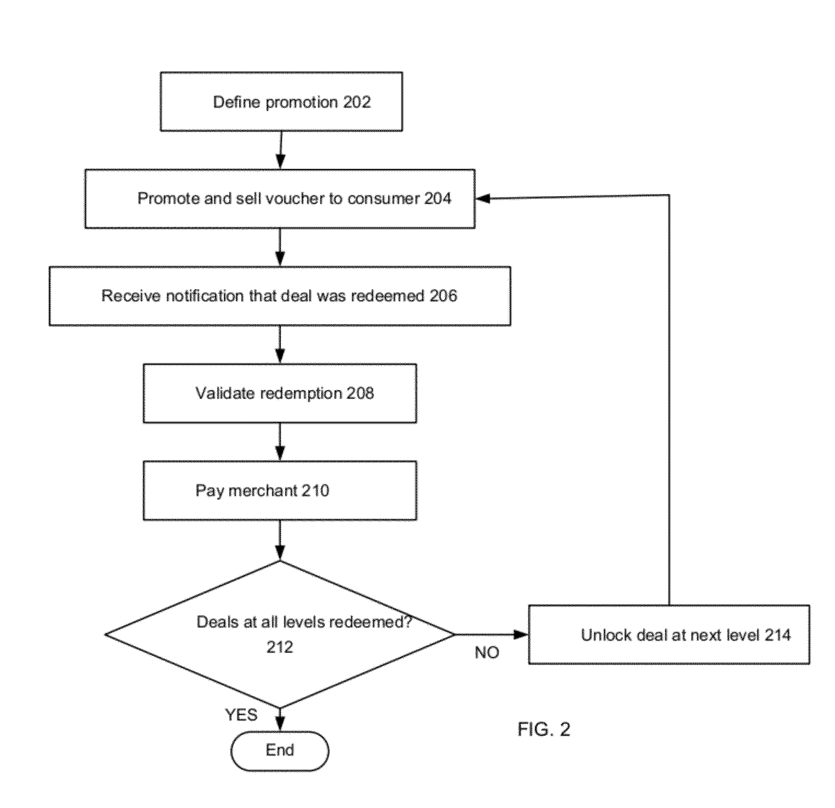

FIG. 2 is a flowchart illustrating an exemplary method of conducting retailing promotions in accordance with one or more embodiments.

At step 202, the promotion for a merchant is defined. The merchant specifies the products or services to be sold and the deals that will be provided at different levels of the promotion. The merchant also specifies the terms and conditions under which the deals are available including, e.g., any expiration dates.

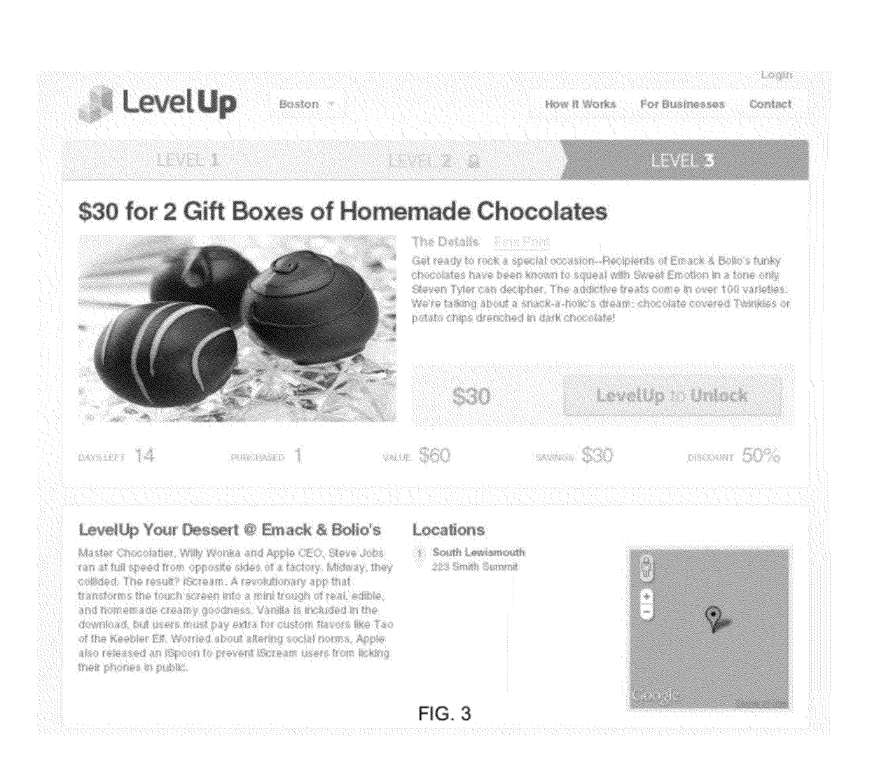

At step 204, the retailing promotion system 100 promotes and sells vouchers for the deals to consumers. Various marketing techniques can be used for selling vouchers, including online advertising, e-mail marketing, social network marketing, and viral marketing. For example, vouchers can be featured on a website hosted by the system 100. FIG. 3 is an example of a website screenshot illustrating a level 3 deal, in which consumers are offered $60 worth of homemade chocolates at a particular store for a price of $30.

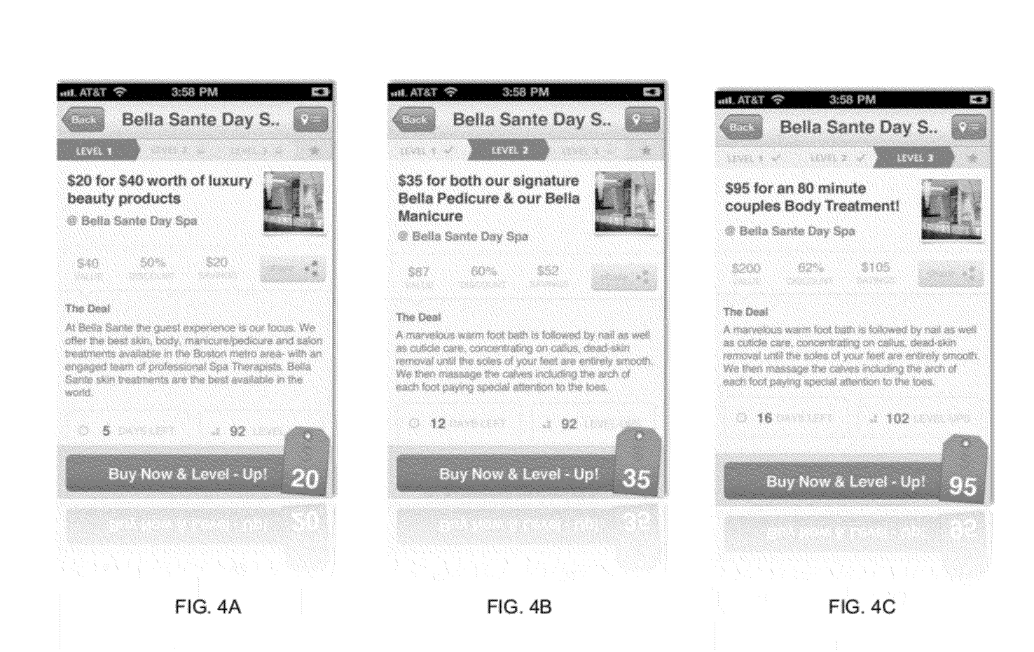

FIGS. 4A-4C feature another example of deals displayed on a smartphone such as, e.g., an iPhone or Android device operated by a consumer. FIGS. 4A, 4B, and 4C show level 1, 2, and 3 deals, respectively, for discounted services and products available from a spa in this example.

Once a voucher has been sold to a consumer, the deal can be redeemed for products or services at the designated merchant. Consumers receive purchased vouchers from the system 100 on their client devices. The vouchers can be printed on paper or alternately displayed on a mobile device, and presented to the merchant for redemption.

The merchant notifies the system 100 at step 206 that a deal has been redeemed. Each voucher includes a unique identifier, e.g., a code, that the merchant can send the system 100 to indicate redemption of the voucher.

At step 208, the system 100 validates the redemption code, and at step 210, pays a fee to the merchant. The fee is preferably based on the voucher price paid by the consumer for the deal. Various payment schemes can be used to determine the amount paid to the merchant. As an example, merchants can receive a percentage (e.g., 75%) of the voucher price collected by the system 100 from the consumer, with the system 100 keeping the balance. In another example, merchants can receive different proportions of the voucher price depending on the level of the voucher. For example, merchants can receive 100% of the voucher price for level 1 deals and 75% of the voucher price for level 2 and 3 deals.

At step 212, a determination is made as to whether deals at all levels of the promotion have been redeemed by the consumer. If so, the process ends. If not, the system 100 unlocks a deal at the next higher level, and the process repeats steps 204-212 until deals at all levels have been redeemed.

In preferred embodiments described above, consumers must both buy and redeem a deal at one level to be able to access a deal at the next level. However, in one or more alternate embodiments, consumers can access a higher level deal by simply buying a lower level deal, regardless of whether the lower level deal is actually redeemed.

In preferred embodiments, each successive level in a promotion provides an increasingly attractive deal to consumers to encourage continued participation. For example, as the level increases, so do the discounts for products or services. For example, in FIGS. 4A-4C, the level 1, 2, and 3 deals provide consumers with savings of $20, $52, and $105, respectively.

In accordance with one or more further embodiments, the retailing promotion system includes a social recommendation engine, which allows consumers to recommend and share deals with friends and others. In particular, once a consumer has unlocked a deal at a given level, the consumer can recommend and share that deal with others, who can buy the deal at the given level without having to have purchased a deal at a lower level. The consumer can share deals with others in various ways including through social networks (e.g., a Facebook posting or a Twitter stream), blogs, text messages, or e-mail.

In preferred embodiments, the vouchers bought by consumers can be used immediately, unlike many known group buying sites that require a threshold number of consumers to purchase vouchers before a deal can become active.

In accordance with one or more further embodiments, the system 100 can generate real time analytical data on voucher sales, redemptions, the number of visits by consumers, and other information.

The processes of the retailing promotion system 100 described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A method of conducting retailing promotions using a computerized retailing promotion system communicating with client devices operated by a plurality of consumers and merchants over a communications network, the method comprising the steps of:
(a) selling vouchers to consumers operating client devices using the computerized retailing promotion system, each said voucher including a deal at one of a plurality of sequential levels that can be redeemed by a consumer at a merchant for a specified product or service, wherein a consumer is entitled to purchase a voucher having a deal at a higher level only if the consumer has purchased a voucher having a deal at an immediately lower level; and
(b) for each consumer redemption of a voucher at a merchant: (i) receiving notification at the computerized retailing promotion system from the merchant when the consumer redeems the voucher; (ii) making a payment to the merchant using the computerized retailing promotion system; (iii) unlocking a deal at the next sequential level, if available, and enabling the consumer to purchase a voucher for that deal; and (iv) repeating steps (i) to (iii) until deals at all levels of a promotion have been sold to the consumer.

2. The method of claim 1, further comprising utilizing online advertising, e-mail marketing, social network marketing, or viral marketing to promote sales of vouchers to consumers.

3. The method of claim 1, wherein the client device operated by a consumer comprises a smart phone having an application for accessing deals on the retailing promotion system.

4. The method of claim 1, wherein each voucher includes a unique identifier and receiving notification from the merchant comprises receiving the unique identifier for a redeemed voucher.

5. The method of claim 1, wherein making a payment to the merchant comprises paying the merchant a percentage of the price of the voucher.

6. The method of claim 5, wherein the percentage of the price varies depending on the level of the deal of the voucher.

7. The method of claim 1, further comprising generating real-time analytical data for merchants on usage of the system.

8. The method of claim 7, wherein the analytical data comprises data on voucher sales, redemptions, and the number of visits by consumers to a merchant.

9. The method of claim 1, wherein deals in each successive level provide progressively increasing discounts for a product or service offered in a voucher.

10. The method of claim 1, wherein a consumer is entitled to purchase a voucher having a deal at a higher level only if the consumer has purchased and redeemed a voucher having a deal at an immediately lower level.

11. The method of claim 1, further comprising enabling consumers to share deals they have unlocked with others.

12. A computerized retailing promotion system capable of communicating with client devices operated by a plurality of consumers and merchants over a communications network, the computerized retailing promotion system being utilized for selling vouchers to consumers via client devices operated by the consumers, each said voucher including a deal at one of a plurality of sequential levels that can be redeemed by a consumer at a merchant for a specified product or service, wherein a consumer is entitled to purchase a voucher having a deal at a higher level only if the consumer has purchased a voucher having a deal at an immediately lower level, and wherein for each consumer redemption of a voucher at a merchant, the computerized retailing promotion system is configured to: (i) receive notification from the merchant when the consumer redeems the voucher; (ii) make a payment to the merchant; (iii) unlock a deal at the next sequential level, if available, and enable the consumer to purchase a voucher for that deal; and (iv) repeat steps (i) to (iii) until deals at all levels of a promotion have been sold to the consumer.

13. The system of claim 12, wherein the computerized retailing promotion system is configured to utilize online advertising, e-mail marketing, social network marketing, or viral marketing to promote sales of vouchers to consumers.

14. The system of claim 12, wherein the client device operated by a consumer comprises a smart phone having an application for accessing deals on the retailing promotion system.

15. The system of claim 12, wherein each voucher includes a unique identifier and receiving notification from the merchant comprises receiving the unique identifier for a redeemed voucher.

16. The system of claim 12, wherein the payment made to the merchant is a percentage of the price of the voucher.

17. The system of claim 16, wherein the percentage of the price varies depending on the level of the deal of the voucher.

18. The system of claim 12, wherein the computerized retailing promotion system is configured generate real-time analytical data for merchants on usage of the system.

19. The system of claim 18, wherein the analytical data comprises data on voucher sales, redemptions, and the number of visits by consumers to a merchant.

20. The system of claim 12, wherein deals in each successive level provide progressively increasing discounts for a product or service offered in a voucher.

21. The system of claim 12, wherein a consumer is entitled to purchase a voucher having a deal at a higher level only if the consumer has purchased and redeemed a voucher having a deal at an immediately lower level.

22. The system of claim 12, wherein the system enables consumers to share deals they have unlocked with others.

23. A computer program product for conducting retailing promotions, said computer program product residing on a non-transitory computer readable medium having a plurality of instructions stored thereon which, when executed by a computer processor, cause that processor to:
(a) sell vouchers to consumers operating client devices, each said voucher including a deal at one of a plurality of sequential levels that can be redeemed by a consumer at a merchant for a specified product or service, wherein a consumer is entitled to purchase a voucher having a deal at a higher level only if the consumer has purchased a voucher having a deal at an immediately lower level; and
(b) for each consumer redemption of a voucher at a merchant: (i) receive notification from the merchant when the consumer redeems the voucher; (ii) make a payment to the merchant; (iii) unlock a deal at the next sequential level, if available, and enable the consumer to purchase a voucher for that deal; and (iv) repeat steps (i) to (iii) until deals at all levels of a promotion have been sold to the consumer.

24. The computer program product of claim 23, further comprising instructions for utilizing online advertising, e-mail marketing, social network marketing, or viral marketing to promote sales of vouchers to consumers.

25. The computer program product of claim 23, wherein the client device operated by a consumer comprises a smart phone having an application for accessing deals on the retailing promotion system.

26. The computer program product of claim 23, wherein each voucher includes a unique identifier and receiving notification from the merchant comprises receiving the unique identifier for a redeemed voucher.

27. The computer program product of claim 23, wherein making a payment to the merchant comprises paying the merchant a percentage of the price of the voucher.

28. The computer program product of claim 27, wherein the percentage of the price varies depending on the level of the deal of the voucher.

29. The computer program product of claim 23, further comprising instructions for generating real-time analytical data for merchants on usage of the system.

30. The computer program product of claim 29, wherein the analytical data comprises data on voucher sales, redemptions, and the number of visits by consumers to a merchant.

31. The computer program product of claim 23, wherein deals in each successive level provide progressively increasing discounts for a product or service offered in a voucher.

32. The computer program product of claim 23, wherein a consumer is entitled to purchase a voucher having a deal at a higher level only if the consumer has purchased and redeemed a voucher having a deal at an immediately lower level.

33. The computer program product of claim 23, further comprising instructions enabling consumers to share deals they have unlocked with others.
